(19) United States
(12) Patent Application Publication
(10) Pub. No.: US 2009/0027732 A1
(43) Pub. Date: Jan. 29, 2009

(54) IMAGE PROCESSING APPARATUS, IMAGE PROCESSING METHOD, AND COMPUTER PROGRAM

(75) Inventor: Toshie Imai, Nagano (JP)

Correspondence Address: EDWARDS ANGELL PALMER & DODGE LLP, P.O. BOX 55874, BOSTON, MA, 02205, US

(73) Assignee: Seiko Epson Corporation, Tokyo (JP)

(21) Appl. No.: 12/179,244

(22) Filed: Jul. 24, 2008

(30) Foreign Application Priority Data
Jul. 24, 2007 (JP) 2007-192299

(51) Int. Cl. G06T 5/00

(52) U.S. Cl. 358/3.27

(57) ABSTRACT

An image processing apparatus comprising an image quality control unit configured to execute a plurality of image quality control processing operations, a type determination unit configured to determine an image type among a plurality of image types in accordance with a feature of an image, and a selection screen generation unit configured to generate a selection screen used to select one of the plurality of image quality control processing operations to be performed on the image in accordance with the determined image type.

### BACKGROUND

1. Technical Field

The present invention relates to an image processing apparatus, an image processing method, and a computer program.

2. Related Art

In recent years, methods for outputting images captured using image pickup apparatus such as digital still cameras (DSCs) and scanners using image outputting apparatus such as printers have become increasingly popular. Such an image outputting apparatus may automatically perform image processing of determining a type of image to be output and controlling quality of the image. An example of the image processing includes processing of controlling pixel values of pixels included in an image (pixel-value control processing) (refer to International Publication No. 2004-070657).

Furthermore, processing of deforming an image represented by image data (deformation processing), such as image processing of modifying a portion of a contour of a face image corresponding to a cheek portion (refer to Japanese Unexamined Patent Application Publication No. 2004-318204), is known. This processing controls an effect of an image, for example.

Although a variety of image control processing operations provide users with new ways of having fun, the users may have to perform complicated operations. In particular, it is difficult for those who do not have sufficient knowledge about image processing to attain desired image quality control effects making use of the variety of image control processing operations. This problem commonly arises in various methods of outputting images including a method of outputting images by printing or in displays.

### SUMMARY

To address this disadvantage, the present invention is implemented as the following embodiments.

### FIRST APPLICATION EXAMPLE

An image processing apparatus includes an image quality control unit configured to execute a plurality of image quality control processing operations, a type determination unit configured to determine an image type among a plurality of image types in accordance with a feature of an image, and a selection screen generation unit configured to generate a selection screen used to select one of the plurality of image quality control processing operations to be performed on the image in accordance with the determined image type.

In the image processing apparatus according to the first application example, since preferable operation candidates are provided for a user from among the plurality of executable image quality control processing operations in accordance with the image type, the burden of an operation of controlling image quality for the user is reduced.

In the image processing apparatus according to the first application example, the selection screen generation unit may determine a priority of the plurality of image quality control processing operations in accordance with the determined image type and generate the selection screen in accordance with the priority. Accordingly, since the selection screen is generated in accordance with the priority, the burden of an operation of controlling image quality for the user is reduced.

In the image processing apparatus according to the first application example, the selection screen generation unit may specify at least one of the plurality of image quality control processing operations in accordance with the determined image type and generate the selection screen used to select one of at least one of the plurality of image quality control processing operations. Accordingly, since limited operation candidates are provided for the user, the burden of an operation of controlling image quality for the user is reduced.

The image processing apparatus according to the first application example may further include a selection learning unit configured to learn selection performed using the selection screen. The selection screen generation unit may generate a selection screen using the determined image type and a result of the learning. Accordingly, since the selection screen is generated taking a trend of selections performed by the user into consideration, the burden of an operation of controlling image quality for the user is reduced.

In the image processing apparatus according to the first application example, the selection screen generation unit may display the plurality of image quality control processing operations that are associated with at least one of the plurality of image types irrespective of the determined image type in response to an instruction issued by a user.

In the image processing apparatus according to the first application example, each of the plurality of image quality control processing operations may include deformation processing of deforming a region included in the image and pixel-value processing of controlling pixel values of pixels included in the image. Accordingly, the user can readily use the various image quality control processing operations each of which includes the deformation processing and the pixel-value processing.

### SECOND APPLICATION EXAMPLE

An image processing method for executing a plurality of image quality control processing operations includes determining an image type among a plurality of image types in accordance with a feature of an image, generating a selection screen used to select one of the plurality of image quality control processing operations to be performed on the image in accordance with the determined image type, and performing one of the plurality of image quality control processing operations selected through the selection screen on the image.

### THIRD APPLICATION EXAMPLE

A computer program for image processing which makes a computer execute an image quality control function of executing a plurality of image quality control processing operations, a type determination function of determining an image type among a plurality of image types in accordance with a feature of an image, and a selection screen generation function of generating a selection screen used to select one of the plurality of image quality control processing operations to be performed on the image in accordance with the determined image type.

The image processing method according to the second application example and the computer program according to the third application example attain effects the same as those attained by the image processing apparatus according to the first application example. Furthermore, as with the image processing apparatus according to the first application example, various modifications may be made for the image processing method according to the second application example and the computer program according to the third application example.

The present invention may be implemented by a recording medium including the computer program according to the third application example or a data signal which includes the computer program and which is realized in a carrier wave.

### BRIEF DESCRIPTION OF THE DRAWINGS

The invention will be described with reference to the accompanying drawings, wherein like numbers reference like elements.

FIG. 1 is a block diagram illustrating a configuration of a printer serving as an image processing apparatus according to an embodiment.

FIG. 2 is a diagram schematically illustrating contents of an image type database.

FIG. 3 is a diagram schematically illustrating contents of a process database.

FIG. 4 is a diagram illustrating an example of a user interface including a list of images.

FIG. 5 is a flowchart illustrating picture processing performed using the printer according to the embodiment.

FIG. 6 is a flowchart illustrating image processing according to the embodiment.

FIGS. 7A and 7B are diagrams illustrating examples of a selection screen according to the embodiment.

FIG. 8 is a flowchart illustrating image quality control processing according to the embodiment.

FIGS. 9A and 9B are graphs illustrating examples of pixel-value processing.

FIGS. 10A and 10B are diagrams illustrating examples of a cheek coloring process.

FIG. 11 is a flowchart illustrating face deformation processing according to the embodiment.

FIG. 12 is a diagram illustrating setting of a deformation region.

FIG. 13 is a diagram illustrating an example of a method for dividing the deformation region into small regions.

FIG. 14 is a diagram illustrating an example of moving processing of division points.

FIG. 15 shows a first table illustrating examples of predetermined movement directions and predetermined movement distances.

FIG. 16 is a diagram schematically illustrating a method for deforming an image.

FIG. 17 is a diagram schematically illustrating a method for deforming an image in a triangular region.

FIG. 18 shows a second table illustrating examples of predetermined movement directions and predetermined movement distances.

FIG. 19 is a diagram illustrating an example of a display unit that displays an image of interest that has been subjected to the image control processing.

FIG. 20 is a flowchart illustrating print processing.

FIG. 21 shows a table illustrating contents of a selection learning database.

FIG. 22 is a flowchart illustrating picture processing according to a first modification.

FIG. 23 is a diagram illustrating another example of the selection screen.

FIG. 24 is a flowchart illustrating image processing according to a third modification.

FIG. 25 is a diagram illustrating still another example of the selection screen.

FIG. 26 is a diagram schematically illustrating an example of an image file including image data and metadata associated with the image data.

### DESCRIPTION OF EXEMPLARY EMBODIMENTS

Embodiments of the present invention will be described with reference to the accompanying drawings.

### A. First Embodiment

### Configuration of Printer

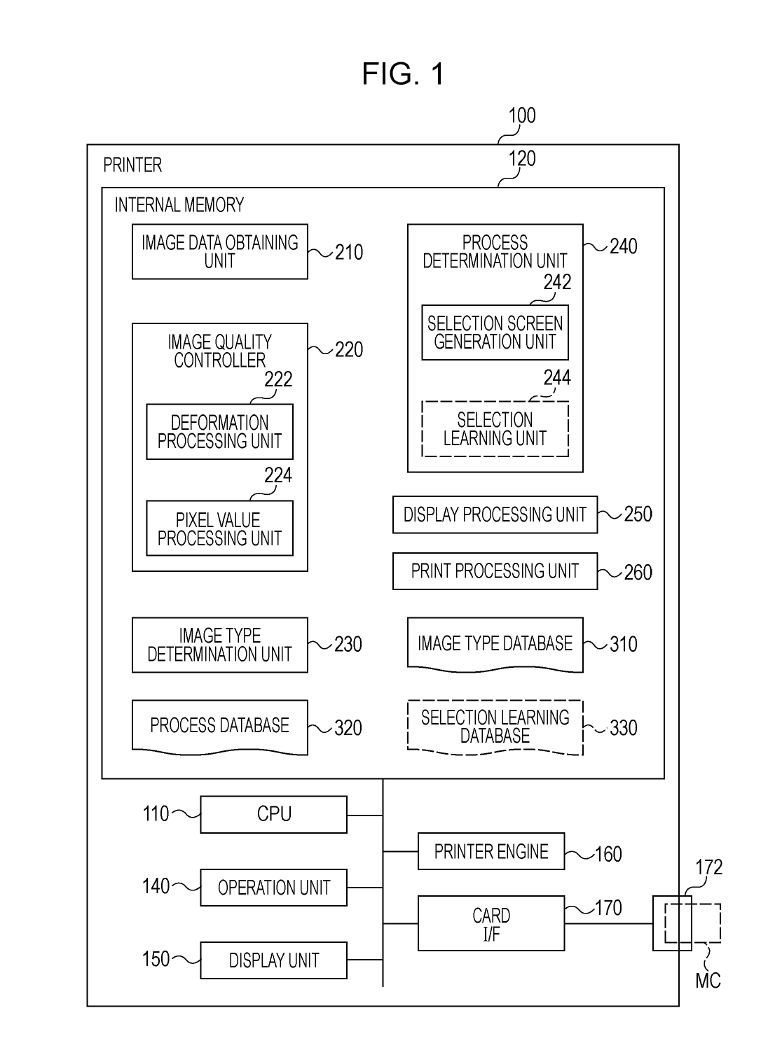

FIG. 1 is a block diagram illustrating a configuration of a printer 100 serving as an image processing apparatus according to an embodiment of the present invention. The printer 100 of this embodiment is a color ink jet printer suitably used for printing an image in accordance with image data obtained from a memory card MC, for example. The printer 100 includes a CPU 110 that controls units in the printer 100, an internal memory 120 including a ROM (read only memory) and a RAM (random access memory), an operation unit 140 including buttons and a touch panel, a display unit 150 including a liquid crystal display, a printer engine 160, and a card interface (card I/F) 170. The printer 100 may further include an interface to perform data communication with another device (a digital still camera, for example). These components of the printer 100 are connected to one another through a bus.

The printer engine 160 is a printing unit that performs print process in accordance with printing data. The card I/F 170 is used to receive data from and transmit data to the memory card MC. Note that in this embodiment, RGB data is stored in the memory card MC as the image data.

The internal memory 120 includes as function units an image data obtaining unit 210, an image quality controller 220, an image type determination unit 230, a process determination unit 240, a display processing unit 250, and a print processing unit 260, which are implemented as computer programs realizing respective predetermined functions by being read from the internal memory 120 and being executed. The image data obtaining unit 210, the image quality controller 220, the image type determination unit 230, and the process determination unit 240 perform image processing that will be described later. The image quality controller 220 includes as sub-modules a deformation processing unit 222 and a pixel-value processing unit 224. The process determination unit 240 includes as a sub-module a selection screen generation unit 242. The display processing unit 250 corresponds to a display driver that controls the display unit 150 to display a process menu or messages. The print processing unit 260 is implemented as a computer program that generates printing data in accordance with image data and controls the printer engine 160 to execute print processing of an image corresponding to the printing data.

The internal memory 120 further includes an image type database 310 and a process database 320. Furthermore, as indicated by a dotted line of FIG. 1, the internal memory 120 may include a selection learning database 330, and the process determination unit 240 may include as a sub-module a selection learning unit 244. A configuration of the printer 100 that additionally includes the selection learning database 330 and the selection learning unit 244 will be described later as a modification.

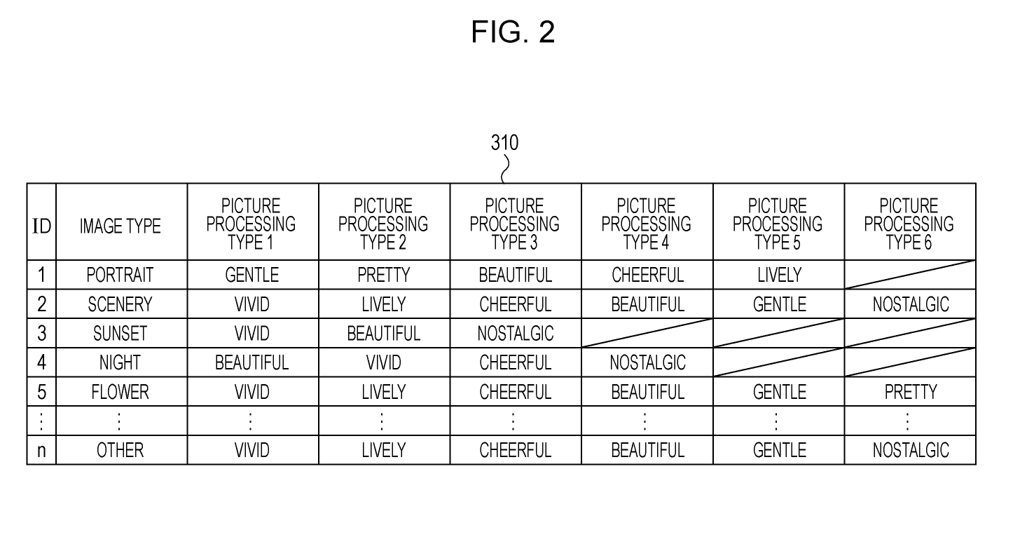

FIG. 2 is a diagram schematically illustrating contents of the image type database 310. A plurality of image types discriminated in accordance with characteristics of images is included in the image type database 310. In this embodiment, the image types are discriminated in accordance with scenes in which images were captured. The plurality of image types including “portrait”, “scenery”, “sunset”, “night”, and “flower” are described in the image type database 310 as shown in FIG. 2. The image type database 310 further includes a single or a plurality of picture processing types to which priorities are assigned. The picture processing types are names for image quality control processing operations performed on images. In this embodiment, terms representing effects of the images that are subjected to the image quality control processing operations are used as the names. Specifically, picture processing types named “gentle”, “beautiful”, and “cheerful”, for example, are included in the image type database 310 as shown in FIG. 2. In FIG. 2, “N” of “picture processing type N (“N” is a natural number)” denotes a priority, and a smaller N denotes a higher priority.

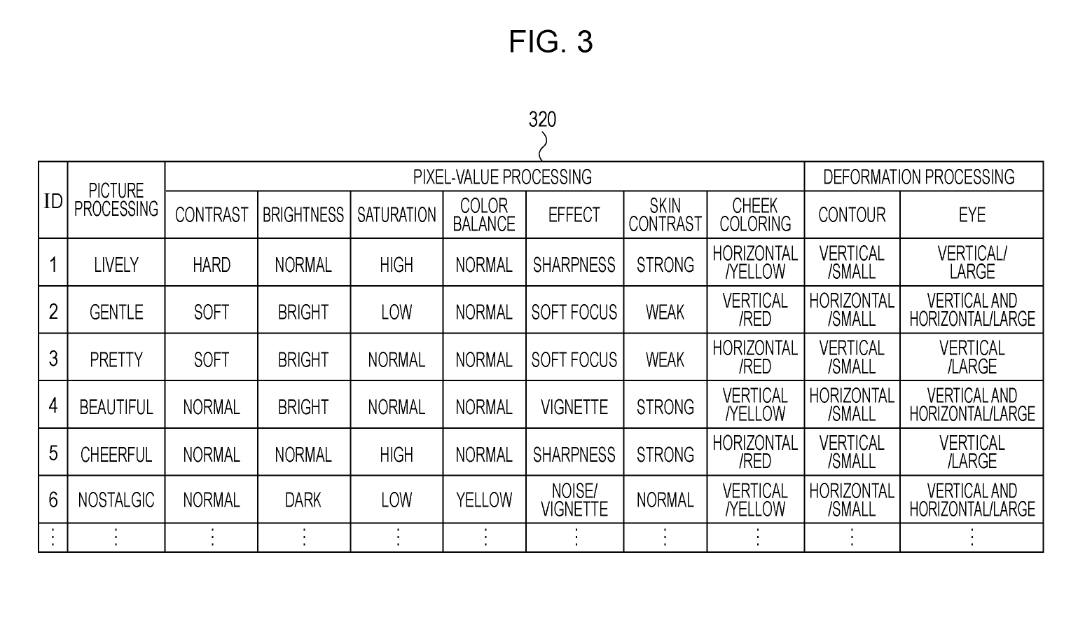

FIG. 3 is a diagram schematically illustrating contents of the process database 320. The process database 320 includes detailed processes of the image quality control processing operations performed for individual picture processing types. Each image quality control processing operations performed for individual picture processing types include pixel-value processing and deformation processing. In the pixel-value processing, pixel values of pixels included in an image are controlled. The pixel-value processing includes processes performed on a specific region of an image, that is, performed on pixels in a face image representing a face of a person in at least one embodiment, such as a process of controlling contrast of skin and a process of coloring cheek portions of a face of the image. The pixel-value processing may further includes processes performed on all pixels in an image, such as a process of controlling contrast and a process of controlling brightness. Moreover, the pixel-value processing may includes a process performed on a number of pixels in an image, such as a sharpness process performed on pixels on an edge region and pixels in the vicinity of the edge region. The deformation processing is performed to deform a region in an image of interest. In at least one embodiment, the face image is deformed by the deformation processing.

For example, as shown in FIG. 3, an image quality control processing operation performed on an image corresponding to a picture processing type of “lively” includes pixel-value processing of a process for attaining a contrast type of “hard”, a process for attaining a brightness type of “normal”, a process for attaining a chroma saturation type of “high”, a process for attaining a color balance type of “normal”, and a process for attaining emphasized sharpness (an effect type of “sharpness”). Furthermore, the image quality control processing operation performed on the image corresponding to a picture processing type of “lively” includes as pixel-value processing performed on a face image a process for attaining a skin contrast type of “strong”, and a process for attaining a cheek color type of “horizontal/yellow” that is performed for horizontally coloring cheek portions of a face image yellow. Moreover, the image quality control processing operation performed on the image corresponding to the picture processing type of “lively” includes as deformation processing performed on a face image a process for attaining a face contour type of “vertical/small” that is performed for making a face contour smaller vertically, and a process for attaining an eye type of “vertical/large” that is performed for making eyes portions of the image larger vertically. By performing the pixel-value processing and the deformation processing on the image corresponding to the picture processing type of “lively”, the image is changed to attain an effect of “lively”.

### Operation of Printer

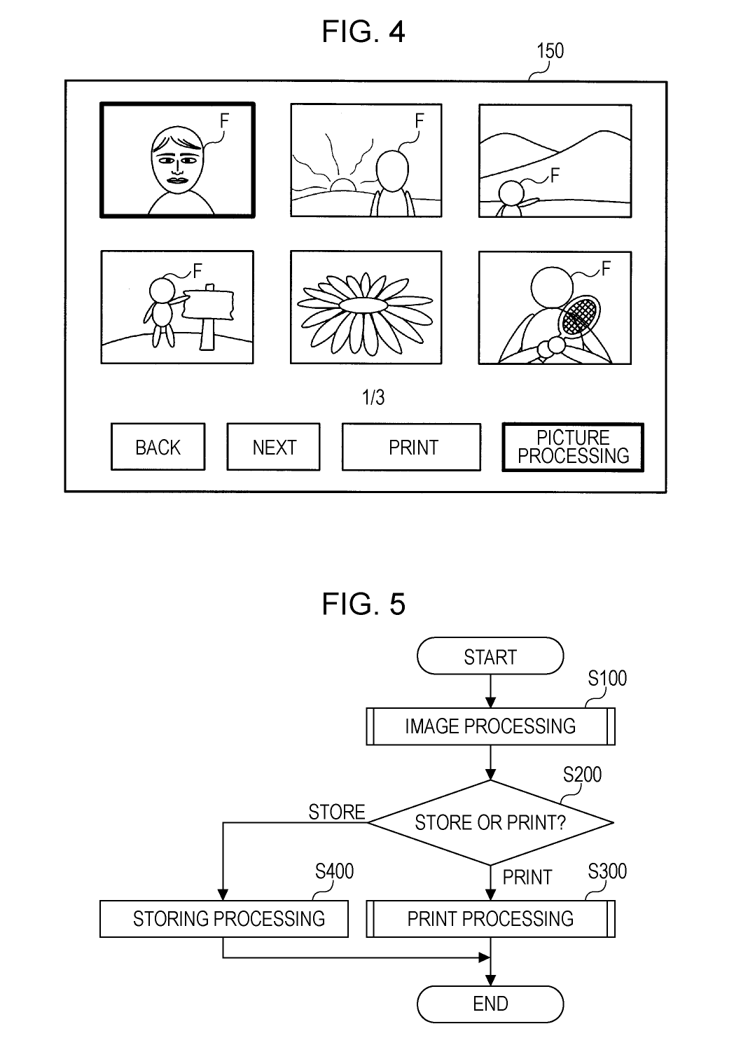

The printer 100 performs print processing in accordance with image data stored on the memory card MC. When the memory card MC is inserted into a card slot 172, the display processing unit 250 controls the display unit 150 to display a user interface including a list of images corresponding to pieces of image data stored in the memory card MC. Some of the images include face images F and the others do not include the face images F. FIG. 4 is a diagram illustrating an example of the user interface including the image list. Note that in this embodiment, the image list is implemented using thumbnail images in the pieces of image data (image files) stored in the memory card MC.

When the user selects one of (or a number of) the images using the user interface shown in FIG. 4 and selects a print button, the printer 100 performs normal print processing of printing the selected image as it is. On the other hand, when the user selects one of (or a number of) the images using the user interface shown in FIG. 4 and selects a picture processing button, the printer 100 performs predetermined image processing on the selected image and prints and stores the processed image (picture processing).

FIG. 5 is a flowchart illustrating the picture processing performed using the printer 100 according to at least one embodiment. When the picture processing is started, the printer 100 performs the image processing on one of the images selected using the user interface in step S100.

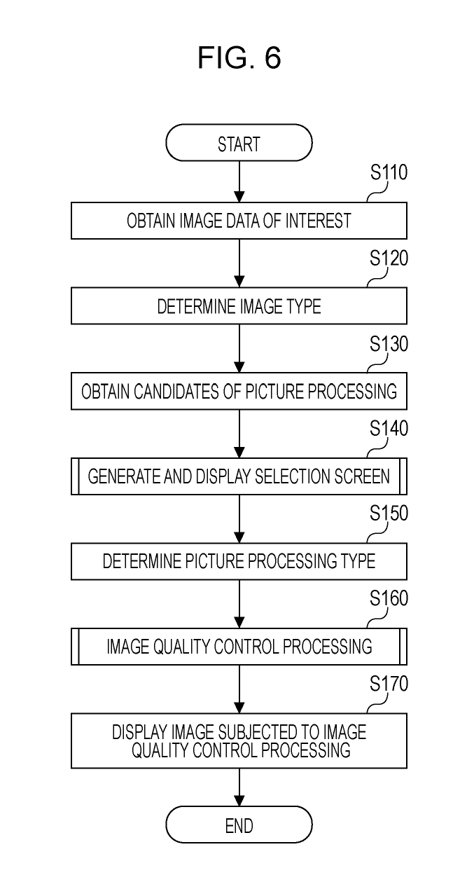

FIG. 6 is a flowchart illustrating the image processing according to the embodiment. When the image processing is started, the image data obtaining unit 210 reads and obtains image data corresponding to the selected image from the card slot 172 in step S110. The obtained image data is stored in a predetermined region of the internal memory 120.

The image type determination unit 230 analyzes the obtained image data and determines an image type of the obtained image (hereinafter referred to as the “image of interest) in step S120. In this embodiment, the image type is determined in accordance with a scene in which the image of interest is captured such as “portrait”, “scenery”, or “night” as described above. Therefore, in this embodiment, the image type of the image of interest is determined through a process of determining a scene in which the image of interest is captured (scene determining process). Various known methods may be employed in the scene determining process. For example, the scene determining process may be performed using a hue (characteristic hue) that characterizes the image of interest and a frequency characteristic of a pixel region having the characteristic hue.

Specifically, the image type determination unit 230 counts the number of pixels that belong to hues of blue, green, ocre, and red for individual hues, and rates of the pixels that belong to the individual hues relative to all pixels are obtained. For example, when it is determined that a pixel value (for example, an HSB value or an RGB value) is within a predetermined range, it is determined that the image of interest has a predetermined hue. The image type determination unit 230 determines the characteristic hue of the image of interest using a map prepared in advance, for example. The map includes rates of the pixels for individual hues and characteristic hues associated with the rates of the pixels.

The image type determination unit 230 determines a pixel region that belongs to the characteristic hue of the image of interest and performs frequency analysis on the determined pixel region. The pixel region that belongs to the characteristic hue is determined on the basis of hues of pixels included in hue information and coordinate position information. The frequency analysis is performed on the determined pixel region in a horizontal direction (lateral direction) and a vertical direction (longitudinal direction) of the image data using a secondary Fourier transformation In this way, a frequency characteristic of the pixel region that belongs to the characteristic hue of the image of interest is obtained.

The image type determination unit 230 determines the scene in which the image of interest is captured (hereinafter referred to as a “photographing scene”) using the characteristic hue and the frequency characteristic of the region that belongs to the characteristic hue (hereinafter referred to as a “characteristic hue region”). For example, the photographing scene is determined as described below. As is apparent from FIG. 2, when the photographing scene is determined, the image type of the captured image is also determined.

(1) It is determined that the captured image corresponds to the image type of “scenery” representing a scenery of greenery mainly including mountains or fields when the characteristic hue is green and high frequency components are mainly included in the frequency of the image as the frequency characteristic.

(2) It is determined that the captured image corresponds to the image type of “scenery” representing a scenery mainly including sky when the characteristic hue is blue and low frequency components are mainly included in the frequency of the image as the frequency characteristic.

(3) It is determined that the captured image corresponds to the image type of “scenery” representing a scenery mainly including sea when the characteristic hue is blue and high frequency components are mainly included in the frequency of the image as the frequency characteristic.

(4) It is determined that the captured image corresponds to the image type of “portrait” representing a portrait of a person when the characteristic hue is ocre and low frequency components are mainly included in the frequency of the image as the frequency characteristic.

(5) It is determined that the captured image corresponds to the image type of “scenery” representing a scenery mainly including a beach and the like when the characteristic hue is ocre and high frequency components are mainly included in the frequency of the image as the frequency characteristic.

(6) It is determined that the captured image corresponds to the image type of “night” representing a night view when the characteristic hue is gray and low frequency components are mainly included in the frequency of the image as the frequency characteristic.

(7) It is determined that the captured image corresponds to the image type of “sunset” representing a sunset view when the characteristic hue is red and low frequency components are mainly included in the frequency of the image as the frequency characteristic.

(8) It is determined that the image was captured by macro photography (closeup) when a specific hue occupies the image as the characteristic hue and the small number of high frequency components are included in the frequency of the image as the frequency characteristic. Furthermore, it is determined that the captured image corresponds to the image type of “flower” representing a scenery including flowers captured by the macro photographing when a number of regions having high chroma saturation are included in the image or when a green hue region is detected.

When the image type is determined by determining the photographing scene, the selection screen generation unit 242 included in the process determination unit 240 obtains picture processing types as candidates (hereinafter referred to as “picture processing candidates”) among the plurality of picture processing types in step S130. Specifically, the selection screen generation unit 242 searches the image type database 310 for the picture processing candidates that are associated with the image type determined in step S120 along with priorities thereof. For example, when the image type corresponds to “portrait”, the picture processing candidates to be obtained are “gentle”, “pretty”, “beautiful”, “cheerful”, and “lively” in an order of the priorities.

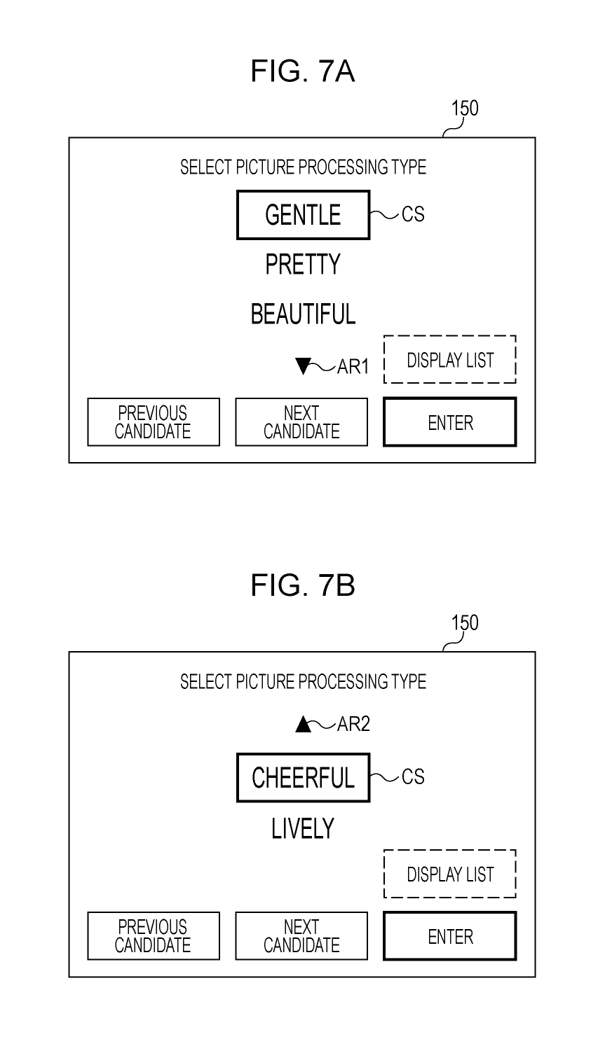

After the picture processing candidates are obtained, a selection screen used to select a picture processing type performed on the image of interest is generated from among the picture processing candidates in step S140. FIGS. 7A and 7B are diagrams illustrating examples of the selection screen according to the embodiment. Specifically, the selection screen generation unit 242 generates pieces of image data corresponding to the names of the obtained picture processing candidates to be displayed in the selection screen in the order of descending priorities as shown in FIG. 7. The display processing unit 250 controls the display unit 150 to display the selection screen showing the pieces of image data representing the picture processing candidates. The user selects a desired picture processing type from among the picture processing candidates by moving the cursor CS and by pressing a “previous candidate” button or a “next candidate” button. An arrow mark AR1 shown in FIG. 7A indicates that at least one picture processing candidate having a priority lower than the priorities of the picture processing candidates currently displayed is hidden. On the other hand, an arrow mark AR2 shown in FIG. 7B indicates that at least one picture having a priority higher than the priorities of the picture processing candidates currently displayed is hidden. In each of FIGS. 7A and 7B, the selection screen may include a “display list” button indicated by a dotted line. A case in which the selection screen includes the “display list” button will be described later as a modification.

The process determination unit 240 receives an input signal in response to a selection of the picture processing type from among the picture processing candidates performed by the user through the selection screen to determine a picture processing type to be employed in step S150. In this way, processes of an image quality control processing operation to be performed on the image of interest are determined (refer to FIG. 3).

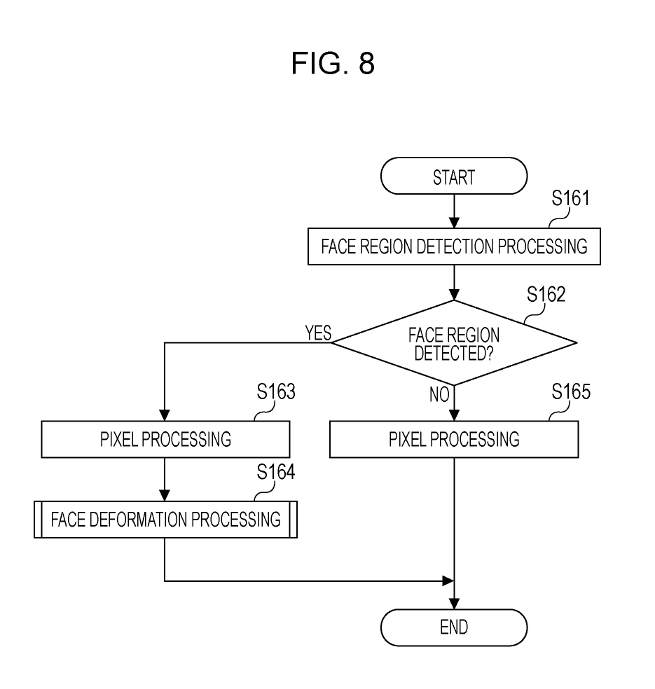

After the picture processing type to be employed is determined, the image quality controller 220 performs the image quality control processing operation on the image of interest in step S160. FIG. 8 is a flowchart illustrating the image quality control processing operation according to at least one embodiment. When the image quality control processing operation is started, the image quality controller 220 performs a detection process on the image of interest to detect a face region FA in step S161. Here, the face region FA corresponds to a portion of the image of interest corresponding to a face of a person. The image quality controller 220 performs the detection process of detecting the face region FA using a known face detection method such as a pattern matching method utilizing a template (refer to Japanese Unexamined Patent Application Publication No. 2004-318204).

When it is determined that the face region FA is not detected (“No” in step S162), only the pixel-value processing is performed in step S165. When it is determined that the face region FA is detected (“Yes” in step S162), the pixel-value processing is performed in step S163, and thereafter, the deformation processing (face deformation processing) is performed on the face portion of the image of interest in step S164.

The pixel-value processing unit 224 of the image quality controller 220 obtains process information of the pixel-value processing to be performed on the image of interest that corresponds to the picture processing type determined in step S150 from the process database 320. The pixel-value processing unit 224 performs the pixel-value processing in accordance with the obtained process information. For example, when the determined picture processing type corresponds to “lively”, the pixel-value processing unit 224 performs the process for attaining a contrast type of “hard”, the process for attaining a brightness type of “normal”, the process for attaining a chroma saturation type of “high”, the process for attaining a color balance type of “normal” and the process for attaining emphasized sharpness (sharpness processing). For example, a target value Baim of the brightness for the brightness type of “normal” is determined in advance. The operation for attaining the brightness of “normal” is performed by controlling brightness levels of the pixels included in the image of interest using a tone curve that will be described later so that an average brightness level Bave that is an average of the brightness levels of the pixels becomes equal to the target value Baim.

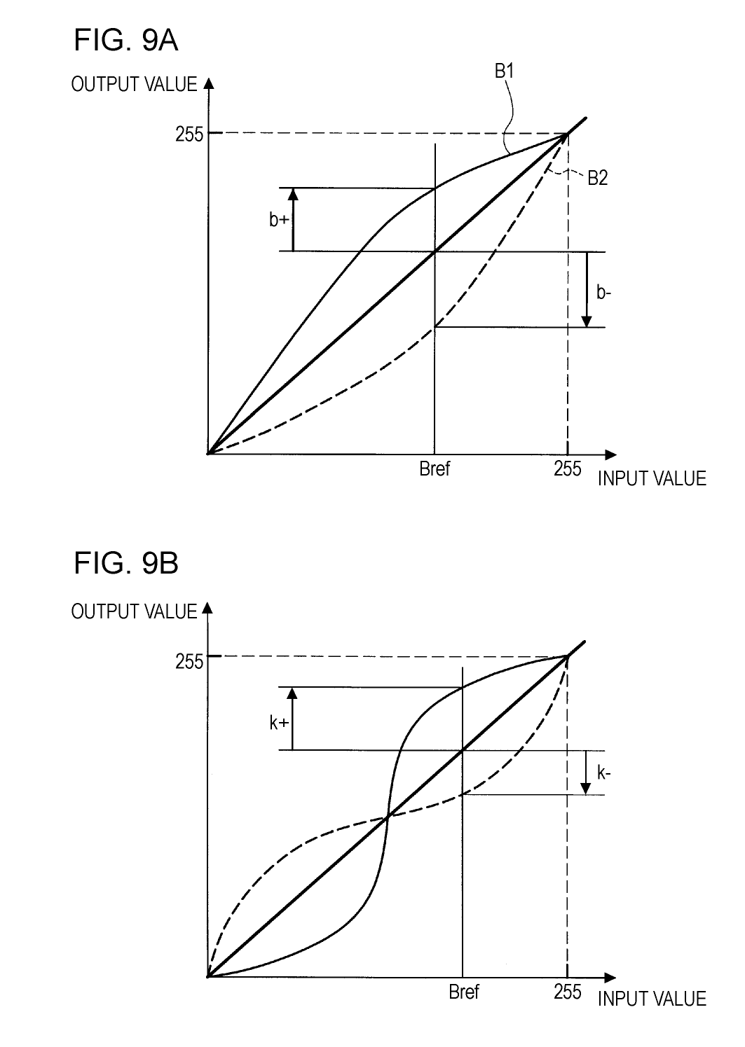

FIGS. 9A and 9B are graphs illustrating examples of pixel-value processing. FIG. 9A shows an example of the tone curve used for processing of controlling brightness. In FIG. 9A, the axis of abscissa denotes an input value of the brightness, and the axis of ordinate denotes an output value of the brightness. The brightness level is based on a B (brightness) value of an HSB color space, for example. In the brightness control processing, brightness conversion using the tone curve is performed on all the pixels of the image of interest. In this embodiment, a degree of the brightness control is determined in accordance with an amount of change of a brightness level output in response to an input reference brightness level Bref. For example, as shown in FIG. 9A, when a positive value of b+ is set to the amount of change of the brightness level, the tone curve has a shape upwardly protruded. The larger the absolute value of the positive value of b+ is, the brighter the image is. On the other hand, when a negative value of b− is set to the amount of change of the brightness level, the tone curve has a shape downwardly protruded. The larger the absolute value of the negative value of b− is, the darker the image is.

FIG. 9B shows an example of the tone curve used for contrast control processing. As with FIG. 9A, the axis of abscissa denotes an input value of the brightness, and the axis of ordinate denotes an output value of the brightness in FIG. 9B. As with the case of the brightness control processing, the brightness conversion using the tone curve is performed on all the pixels of the image of interest in the contrast control processing. In this embodiment, a degree of the contrast control is determined in accordance with an amount of change of a brightness level output in response to the input reference brightness level Bref. For example, as shown in FIG. 9B, when a positive value of k+ is set to the amount of change of the brightness level, the tone curve has an S-shape. The larger the absolute value of the positive value of k+ is, the stronger (harder) the contrast of the image is. On the other hand, when a negative value of k− is set to the amount of change of the brightness level, the tone curve has an inversed S-shape. The larger the absolute value of the negative value of k− is, the weaker (softer) the contrast is.

Chroma saturation control processing is executed by performing conversion using a tone curve similar to the tone curve shown in FIG. 9A on a chroma saturation value (for example, an S (saturation) value of the HSB color space).

Color balance control processing is performed using a method for controlling color components so that an average value of pixel values (form example, RGB values) of all pixels constituting an image attains a predetermined value representing a target color. For example, when a color balance type of “normal” is to be attained, an achromatic color (white or gray) is set to the target color. When a color balance type of “yellow” is to be attained, a color obtained by adding a yellow color (component) to an achromatic color is set to the target color.

Sharpness processing is implemented by a method utilizing an unsharp mask. In this method, data (unsharp data) in which brightness represented by brightness values vaguely change is prepared, a difference value obtained by subtracting the unsharp data from original data is multiplied by a coefficient, and a resultant value is added to the original data. By this, the brightness is sharply changed. The unsharp data is obtained by averaging the brightness values of pixels in the original data using brightness values in the vicinity of the pixels (smoothing processing). In the smoothing process, for example, as pixels are located closer to pixels of interest, averages of brightness values of the pixels are calculated with larger weights. The two-dimensional Gaussian function may be used as a weighting function by setting each of the pixels of interest as a center.

Soft focus processing is performed by replacing the unsharp data with the original data. The sharpness processing and the soft focus processing are not required to be performed on all the pixels included in the image of interest, and may be performed only on the pixels included in the edge region and the pixels located in the vicinity of the edge region for example.

Vignette processing is performed in order to reduce brightness values of pixels located in four corners of an image. A retro-flavored image is obtained through the vignette processing.

Noise processing is performed in order to add a predetermined noise to brightness values of pixels constituting an image, for example. Examples of such noise include noise of Gaussian distribution and noise of uniform distribution. The noise processing adds granular texture (roughness) to the image, and when the noise processing is performed along with the vignette processing, the image having a nostalgic effect is attained.

When the face region FA is detected, the pixel value processing unit 224 performs the pixel-value processing on the face image in accordance with the obtained process information. For example, when the determined picture processing type is “lively”, the pixel value processing unit 224 performs the process for attaining a skin contrast of “strong” and the process of coloring the cheek portions of the face image in yellow in a horizontal direction, that is, a cheek color of “horizontal/yellow” (a cheek coloring process).

The process of controlling skin contrast is performed to control contrast of pixels corresponding to skin of the face image. Specifically, the pixel value processing unit 224 performs the process of controlling skin contrast using the tone curve shown in FIG. 9B on pixels having a hue of a predetermined skin color among pixels included in the face region FA and in the vicinity of the face region FA.

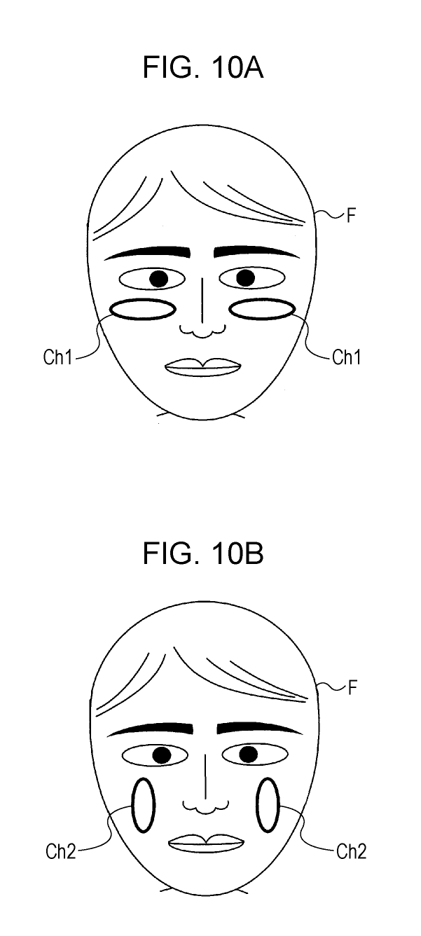

FIGS. 10A and 10B are diagrams illustrating examples of the cheek coloring process. When the cheek portions of the face image are intended to be colored in a horizontal direction, a predetermined color (red or yellow in this embodiment) is added to pixel values of pixels included in regions Ch1 which are located below eye portions of the image and which are horizontally elongated as shown in FIG. 10A. When the cheek portions of the face image is intended to be colored in a vertical direction, the predetermined color is added to pixel values of pixels included in regions Ch2 which are located below eye portions of the image and which are vertically elongated as shown in FIG. 10B. Furthermore, the regions Ch1 and Ch2 are determined by detecting portions of the image corresponding to organs such as eyes and a mouth in the detected face region FA and by referring to a positional relationship among the portions.

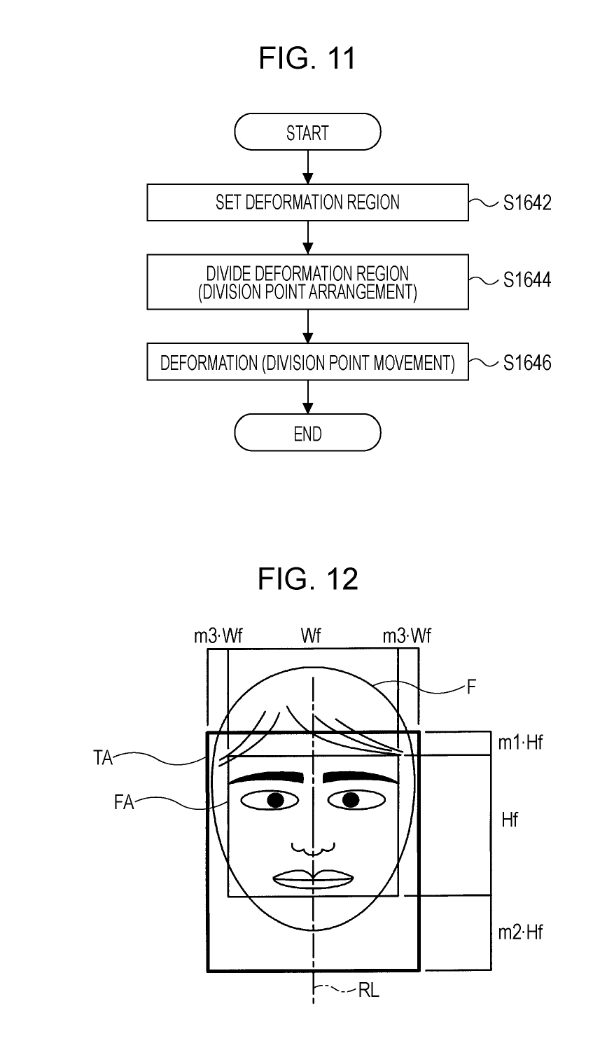

After it is determined that the face region FA was detected, when the pixel-value processing is terminated in step S163, the deformation processing unit 222 included in the image quality controller 220 performs the face deformation processing in step S164. FIG. 11 is a flowchart illustrating the face deformation processing according to the embodiment. The deformation processing unit 222 starts the face deformation processing and sets a deformation region TA which includes a portion of the face image or all the face image in step S1642.

FIG. 12 is a diagram illustrating setting of the deformation region TA. As shown in FIG. 12, in this embodiment, the face region FA to be detected corresponds to a rectangular region including eye portions, a nose portion, and a mouth portion of the face image in the image of interest. Note that a reference line RL shown in FIG. 12 defines a height direction (vertical direction) of the face region FA and denotes a center of the face region FA in a width direction (horizontal direction). That is, the reference line RL passes through a gravity point of the rectangular face region FA and extends in parallel to a boundary line extending along the height direction (vertical direction) of the face region FA. The deformation region TA is included in the image of interest and is to be subjected to the image deformation processing of modifying a face shape. As shown in FIG. 12, in this embodiment, the deformation region TA is obtained by expanding (and shrinking) the face region FA in a direction in parallel to the reference line RL (the height direction) and in a direction orthogonal to the reference line RL (the width direction). Specifically, assuming that a length of the face region FA in the height direction is denoted by Hf and a length of the face region FA in the width direction is denoted by Wf, the deformation region TA is obtained by expanding the face region FA by m1 Hf upward, by m2 Hf downward, by m3 Wf leftward, and by m3 WF rightward. Note that m1, m2, and m3 denote predetermined coefficients.

As described above, when the deformation region TA is set, the reference line RL which extends in parallel to a contour line extending in the height direction of the face region FA is also parallel to a contour line extending in the height direction of the deformation region TA. Furthermore, the reference line RL equally divides the width of the deformation region TA into two.

As shown in FIG. 12, the deformation region TA substantially includes a portion of the face image ranging from a chin portion to a forehead portion in the height direction, and includes a portion of the face image ranging from a left cheek portion to a right cheek portion in the width direction. Specifically, in this embodiment, the coefficients m1, m2, and m3 are preset with reference to a size of the face region FA so that the deformation region TA substantially includes a portion of the image defined by these ranges.

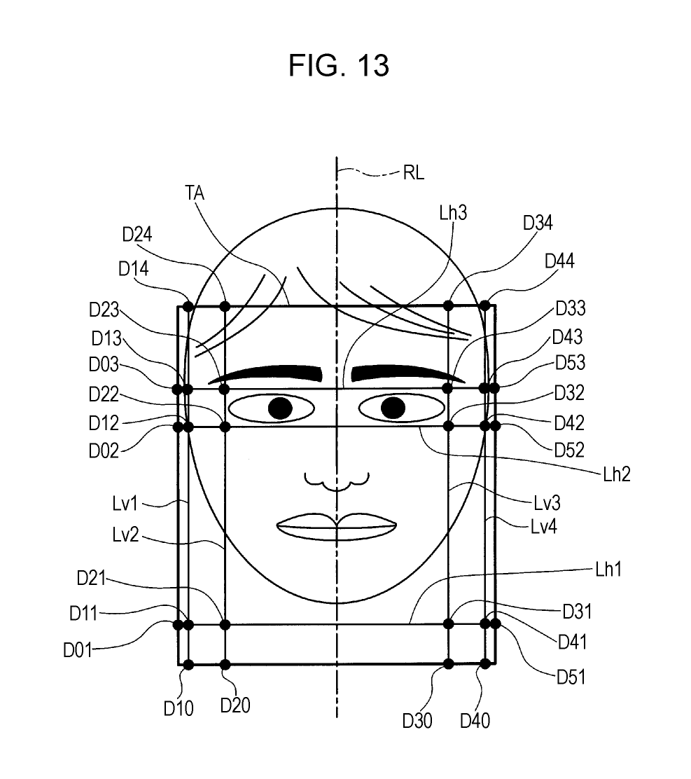

When the deformation region TA is set, the deformation processing unit 222 divides the deformation region TA into a plurality of small regions in step S1644. FIG. 13 is a diagram illustrating an example of a method for dividing the deformation region TA into the plurality of small regions. The deformation processing unit 222 arranges a plurality of division points D in the deformation region TA, and divides the deformation region TA into the plurality of small regions using lines connecting the division points D.

The arrangement (the number of the division points D and positions of the division points D) of the division points D is performed using a predetermined pattern in accordance with a method for deforming the face image. For example, a pattern table (not shown) including arrangement patterns which are associated with face image deformation methods is prepared, and the deformation processing unit 222 arranges the division points D in accordance with one of the deformation methods with reference to the pattern table. A case where a contour of the face image is deformed to be horizontally small, that is, “horizontal/small” in FIG. 3, will be described as an example of the deformation processing hereinafter.

As shown in FIG. 13, the division points D are arranged at intersections of horizontal division lines Lh and vertical division lines Lv, intersections of the horizontal division lines Lh and a frame of the deformation region TA, and intersections of the vertical division lines Lv and the frame of the deformation region TA. Note that the horizontal division lines Lh and the vertical division lines Lv are reference lines for arrangement of the division points D in the deformation region TA. As shown in FIG. 13, when the contour is deformed to be horizontally smaller, the three horizontal division lines Lh which extend orthogonal to the reference line RL and the four vertical division lines Lv which extend in parallel to the reference line RL are set. The three horizontal division lines Lh include horizontal division lines Lh1, Lh2, and Lh3 from a lower side of the deformation region TA. The four vertical division lines Lv include vertical division lines Lv1, Lv2, Lv3 and Lv4 from a left side of the deformation region TA.

The horizontal division line Lh1 is arranged below the chin portion in the deformation region TA of the image, the horizontal division line Lh2 is arranged immediately below the eye portions in the deformation region TA of the image, and the horizontal division line Lh3 is arranged immediately above the eye portions in the deformation region TA of the image. The vertical division lines Lv1 and Lv4 are arranged outside the cheek portions of the image, and the vertical division lines Lv2 and Lv3 are arranged outside the eye portions of the image. Note that the horizontal division lines Lh and the vertical division lines Lv are arranged with reference to the size of the deformation region TA set in advance so that a positional relationship between the horizontal division lines Lh, the vertical division lines Lv, and the image corresponds to the positional relationship described above.

In accordance with the arrangement of the horizontal division lines Lh and the vertical division lines Lv, the division points D are arranged at the intersections of horizontal division lines Lh and vertical division lines Lv, the intersections of the horizontal division lines Lh and the frame of the deformation region TA, and the intersections of the vertical division lines Lv and the frame of the deformation region TA. As shown in FIG. 13, division points D located on horizontal division lines Lhi (i=1 or 2) include division points D0i, D1i, D2i, D3i, D4i, and D5i. For example, division points D located on the horizontal division line Lh1 include division points D01, D11, D21, D31, D41, and D51. Similarly, the division points D located on vertical division lines Lvj (j=1, 2, 3, or 4) include division points Dj0, Dj1, Dj2, and Dj3. For example, division points D located on the vertical division line Lv1 include division points D10, D11, D12, and D13.

Note that, as shown in FIG. 13, the division points D are symmetrically arranged relative to the reference line RL.

The deformation processing unit 222 divides the deformation region TA into the plurality of small regions as described above using lines (i.e., the horizontal division lines Lh and the vertical division lines Lv) which connect the arranged division points D with one another. In this embodiment, the deformation region TA is divided into 20 small rectangular regions as shown in FIG. 13.

The deformation processing unit 222 performs the deformation processing on a portion of the image of interest corresponding to the deformation region TA in step S1646. In the deformation processing, the division points D arranged in the deformation region TA are moved to deform the small regions.

A method (a movement direction and a movement distance) for moving the division points D in the deformation processing is determined in advance in accordance with a method of the deformation processing. The deformation processing unit 222 moves the division points D in the predetermined movement direction and by the predetermined movement distance.

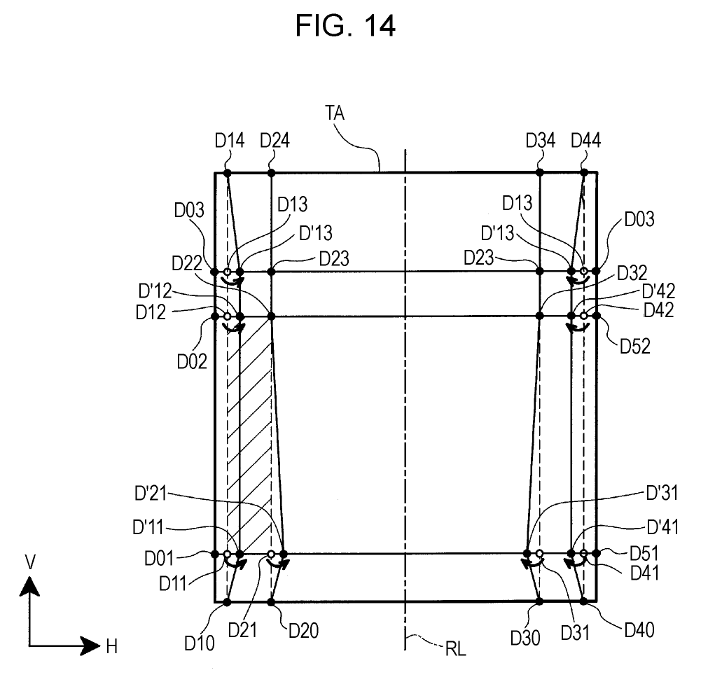

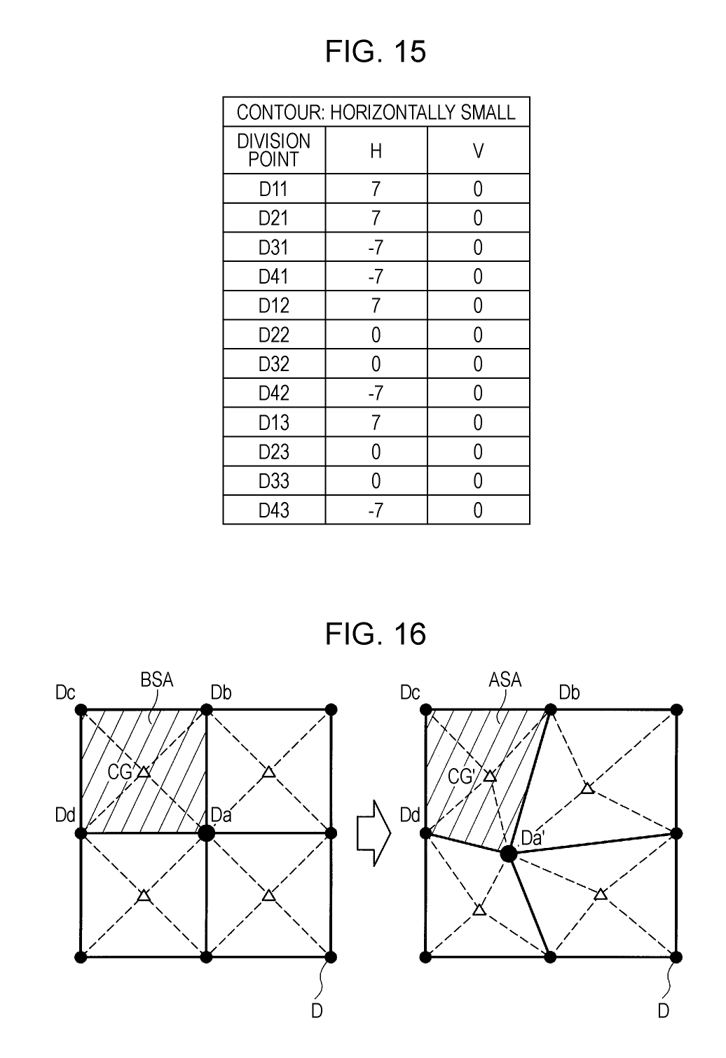

FIG. 14 is a diagram illustrating an example of moving process of the division points D. FIG. 15 shows a first table illustrating examples of predetermined movement directions and predetermined movement distances. FIG. 15 shows movement directions and movement distances when the contour of the face image is deformed to be horizontally smaller. FIG. 15 shows amounts of movements of the individual division points D in a direction (an H direction) orthogonal to the reference line RL and in a direction (a V direction) parallel to the reference line RL. Since these pieces of data are stored in the internal memory 120 as a table, the deformation processing unit 222 may readily perform the deformation processing with different methods. Note that a unit of the amounts of movements shown in FIG. 15 is a pixel pitch PP of the image of interest. In movement in the H direction, an amount of movement in a rightward direction of FIG. 13 is represented by a positive value whereas an amount of movement in a leftward direction of FIG. 13 is represented by a negative value. In movement in the V direction, an amount of movement in an upward direction of FIG. 13 is represented by a positive value whereas an amount of movement in a downward direction of FIG. 13 is represented by a negative value. For example, the division point D11 is moved to the right in the H direction by a distance seven times the pixel pitch PP, and is not moved in the V direction (moved by a distance 0 times the pixel pitch PP). Furthermore, the division point D22 is moved by a distance 0 times the pixel pitch PP in the H direction and the V direction, that is, the division point D22 is not moved.

Note that, in this embodiment, among all the division points D, division points D (such as the division point D10 shown in FIG. 13) located on the frame of the deformation region TA are not moved so that a boundary between the portion of the image inside the deformation region TA and a portion of the image outside the deformation region TA is prevented from being unnatural. Accordingly, methods for moving the division points D located on the frame of the deformation region TA are not shown in FIG. 15.

In FIG. 14, among all the division points D, division points D before being subjected to the moving processing are denoted by white circles, and division points D after being subjected to the moving processing and division points D which are prevented from being moved are denoted by black circles. The division points D after being subjected to the moving processing are represented by division points D′. For example, the division point D11 is moved to the right and is then represented by a division point D11′ in FIG. 14.

Note that, in this embodiment, all pairs of two division points D which are symmetrically arranged relative to the reference line RL (for example, a pair of the division points D11 and D41) maintain positional relationships thereof even after the division points D are moved.

The deformation processing unit 222 performs the deformation processing on the image so that portions of the image in the plurality of small regions in the deformation region TA before the division points D are moved are changed to portions of the image in a plurality of small regions newly defined by moving the division points D. For example, in FIG. 14, a portion of the image corresponding to a small region (a hatched small region) defined by the division points D11, D21, D22, and D12 serving as vertices is deformed to obtain a portion of the image corresponding to a small region defined by the division points D′11, D′21, D22, and D′12 serving as vertices.

FIG. 16 is a diagram schematically illustrating a method for deforming the image. In FIG. 16, the division points D are denoted by black circles. In FIG. 16, four small regions are taken as an example for simplicity, and a left diagram shows a state in which the division points D have not yet been subjected to the moving processing and a right diagram shows a state in which the division points D have been subjected to the moving processing. In the example shown in FIG. 16, a center division point Da is moved to a position of a division point Da′, and other division points D are not moved. Accordingly, for example, a portion of an image corresponding to a small rectangular region (hereinafter referred to as a “before-deformation small region BSA”) defined by the division points Da, Db, Dc, and Dd serving as vertices is deformed to become a portion of the image corresponding to a small rectangular region (hereinafter referred to as an “after-deformation small region ASA”) defined by the division points Da′, Db, Dc, and Dd serving as vertices.

In this embodiment, each of the rectangular small regions is divided into four triangular regions using a center of gravity CG of a corresponding one of the small region, and the deformation processing is performed on an image for individual triangular regions. In the example shown in FIG. 16, the before-deformation small region BSA is divided into four triangular regions using the center of gravity CG as one of vertices of each of the triangular regions. Similarly, the after-deformation small region ASA is divided into four triangular regions using a center of gravity CG′ as one of vertices of each of the triangular regions. Then, the deformation processing is performed on the image for individual triangular regions so that the triangular regions in the before-deformation small region BSA are changed to the triangular regions in the after-deformation small region ASA. For example, a portion of the image corresponding to a triangular region defined by the division points Da and Dd and the center of gravity CG as vertices in the before-deformation small region BSA is deformed so that a portion of the image corresponding to a triangular region defined by the division points Da′ and Dd and the center of gravity CG′ as vertices in the after-deformation small region ASA is obtained.

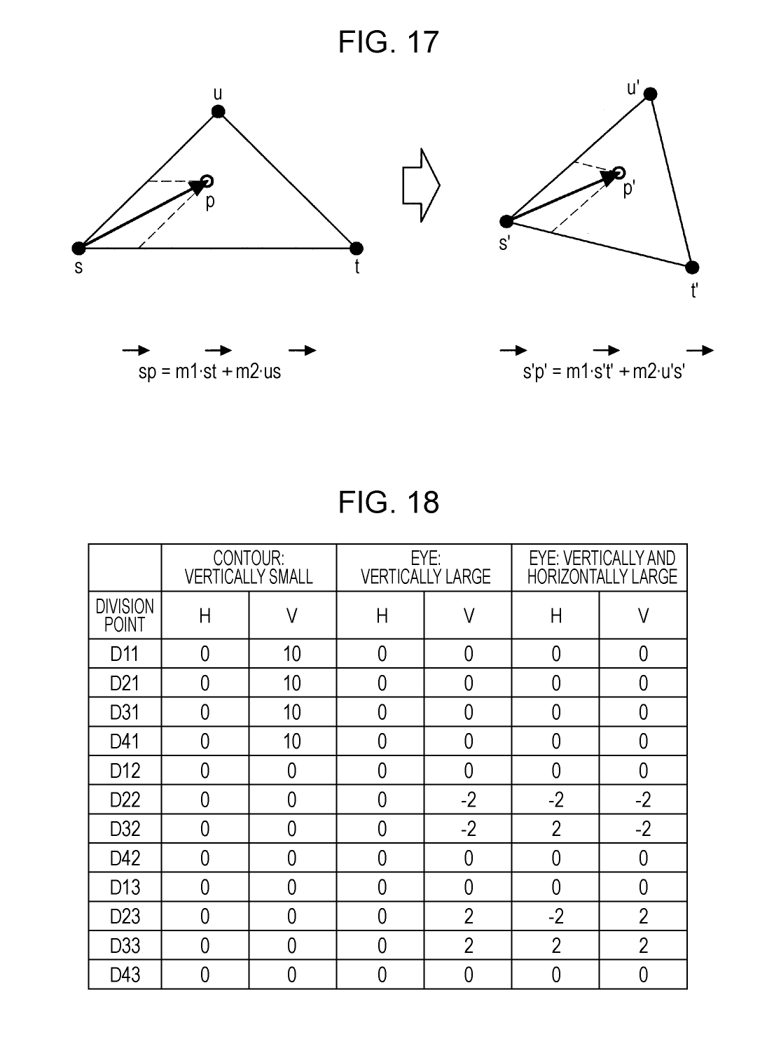

FIG. 17 is a diagram schematically illustrating a method for deforming an image in a triangular region. In FIG. 17, a portion of an image defined by points s, t, and u serving as vertices is deformed so that a portion of the image defined by points s′, t′, and u′ serving as vertices is obtained. In the deformation processing performed on the image, positions of pixels in the portion of the image corresponding to the triangular region stu which has not yet been subjected to the deformation processing which correspond to positions of pixels in the portion of the image corresponding to the triangular region s′t′u′ which has been subjected to the deformation processing are detected. Thereafter, pixel values of the pixels in the portion of the image corresponding to the triangular region stu which has not yet been subjected to the deformation processing are changed to pixel values of the pixels in the portion of the image corresponding to the triangular region s′t′u′ which has been subjected to the deformation processing.

For example, in FIG. 17, a position of a pixel of interest p′ in the portion of the image corresponding to the triangular region s′t′u′ corresponds to a position p in the portion of the image corresponding to the triangular region stu. The position p is calculated as follows. First, coefficients m1 and m2 are obtained to be used when the position of the pixel of interest p′ is obtained by a sum of a vector s′t′ and a vector s′u′ using the following equation (1)

Equation 1

s̅′̅p̅′̅=m1· s̅′̅t̅′̅+m2· s̅′̅u̅′̅ (1)

Then, the position p is obtained by calculating a sum of a vector st and a vector su of the rectangular region stu using the following equation (2) employing the obtained coefficients m1 and m2.

Equation 2

s̅p̅=m1· s̅t̅+m2· s̅u̅ (2)

When the position p of the triangular region stu coincides with a center pixel of the image before deformation, a pixel value of the center pixel is determined as a pixel value of the image after deformation. On the other hand, when the position p of the triangular region stu corresponds to a portion which is shifted from the center pixel of the image before deformation, the pixel value of the position p is calculated using interpolation calculation such as bicubic interpolation which uses pixel values of pixels in the vicinity of the position p, and the calculated pixel value is used as the pixel value of the image after deformation.

Since the pixel values of the pixels in the portion of the image corresponding to the triangular region s′t′u′ after deformation are calculated as described above, the image deformation processing of deforming the portion of the image corresponding to the triangular region stu to obtain the portion of the image corresponding to the triangular region s′t′u′ is performed. The deformation processing unit 222 performs the deformation processing by defining triangular regions for individual small regions in the deformation region TA as described above to deform the portion of the image included in the deformation region TA.

The face deformation processing is described as above taking a case where the contour of the face image is deformed to be horizontally small as an example. Other deformation methods may be readily performed by changing the movement directions and the movement distances shown in FIG. 15 in accordance with the deformation methods. FIG. 18 shows a second table illustrating examples of the predetermined movement directions and the predetermined movement distances. FIG. 18 shows movement directions and movement distances employed in a case where the contour of the face image is deformed to be vertically small, a case where the eye portions of the face image are deformed to be vertically large, and a case where the eye portions of the face image are deformed to be vertically and horizontally large.

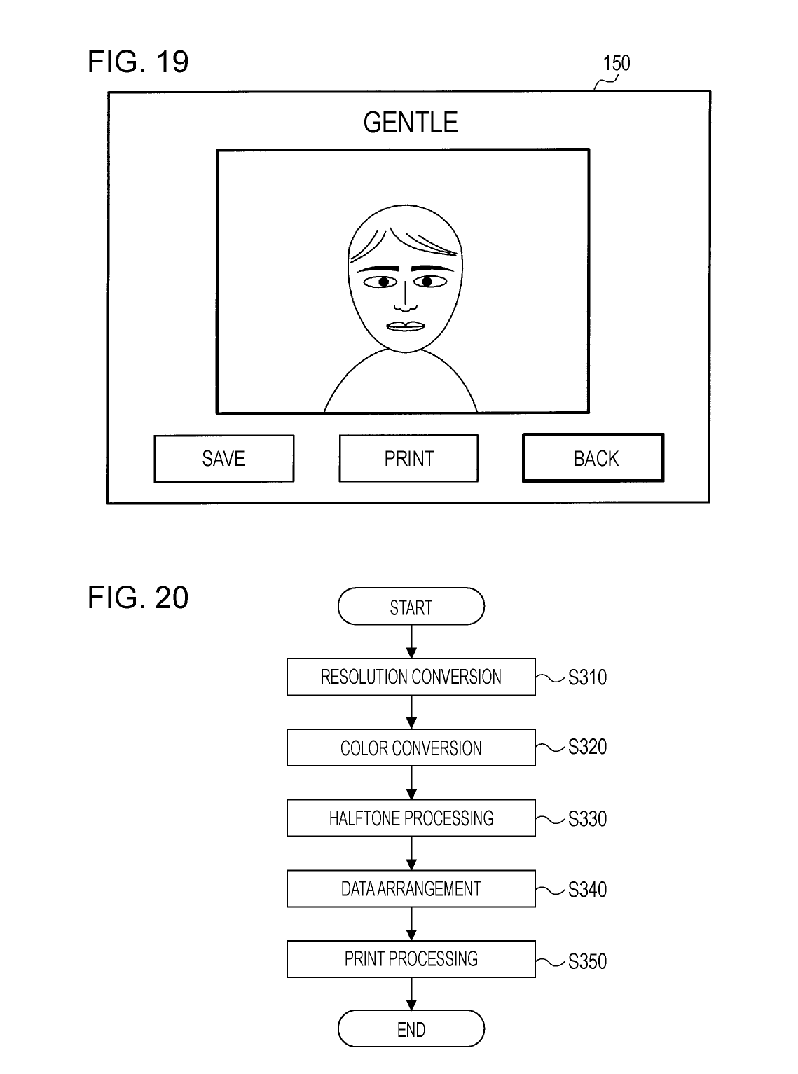

When the image quality control processing is terminated, the image quality controller 220 controls the display processing unit 250 to display the image of interest that has been subjected to the image quality control processing in the display unit 150. FIG. 19 is a diagram illustrating an example of the display unit 150 displaying the image of interest that has been subjected to the image quality control processing. The user checks a result of the image quality processing performed in accordance with the selected picture processing type through the display unit 150 in which the image of interest that has been subjected to the image quality processing is displayed. When the user is satisfied with the result of the image quality control processing and presses a “save” button in step S200 of FIG. 5, processing of storing image data representing the image of interest which has been subjected to the image quality control processing is performed in step S400. For example, the image of interest (bitmap data) that has been subjected to the image quality control processing is compressed in a predetermined format such as a JPEG format, and the compressed data is stored as an image file in accordance with a predetermined file format such as an EXIF format. The image file may be stored in the inserted memory card MC. In this case, an image file corresponding to the image of interest that has not yet been subjected to the image quality control processing may be replaced by the image file corresponding to the image of interest that has been subjected to the image quality control processing. Alternatively, the image file corresponding to the image of interest that has been subjected to the image quality control processing may be stored separately from the image file corresponding to the image of interest that has not yet been subjected to the image quality control processing.

When the user is satisfied with the result of the image quality control processing and selects a “print” button in step S200 of FIG. 5, the print processing unit 260 performs print processing on the image of interest which has been subjected to the image quality control processing in step S300. FIG. 20 is a flowchart illustrating the print processing. The print processing unit 260 converts a resolution of the image data corresponding to the image of interest which has been subjected to the image quality control processing into a resolution suitable for the print processing performed using the printer engine 160 in step S310. Then, the image data which has been subjected to the resolution conversion is converted into ink-color image data having gradation levels using a plurality of ink colors used in the print processing performed by the printer engine 160 in step S320. Note that, in this embodiment, the plurality of ink colors used in the print processing performed by the printer engine 160 include four colors, i.e., cyan (C), magenta (M), yellow (Y), and black (K). The print processing unit 260 generates pieces of dot data representing states of formations of ink dots for individual print pixels by performing halftone processing in accordance with gradation values of the ink colors for the ink-color image data in step S330. Thereafter, the pieces of dot data are aligned so that printing data is generated in step S340. The print processing unit 260 supplies the generated printing data to the printer engine 160, and the printer engine 160 performs the print processing on the image of interest which has been subjected to the image quality control processing in step S350. The print processing is thus terminated.

When the user is not satisfied with the result of the image quality control processing and selects a “back” button, the selection screen used to select one of the picture processing types is displayed on the display unit 150 as shown in FIGS. 7A and 7B, for example, and the user selects another desired picture processing type among the displayed picture processing types (not shown).

In the foregoing embodiment, a single image quality control processing operation includes a combination of the deformation processing of deforming a face image and the pixel-value processing of controlling pixel values. Accordingly, the user can readily execute the deformation processing and the pixel-value processing by merely selecting one of the image quality control processing operations.

Furthermore, in this embodiment, each of the image quality control processing operations which includes the combination of the deformation processing of deforming a face image and the pixel-value processing of controlling pixel values is associated with a corresponding one of the picture processing types having the names such as “pretty”, “gentle”, and “cheerful” which correspond to the effects of the image of interest which has been subjected to the image quality control processing. Accordingly, the user can select a desired combination of the deformation processing and the pixel-value processing in a sentient manner. For example, a combination of a process for attaining a skin contrast type of “weak” of the pixel-value processing and a process for attaining a face contour type of “vertical/small” of the deformation processing which is performed for making a face contour smaller vertically is effective in order to attain a “pretty” effect of a face image. However, it is not easy for a user who does not have sufficient knowledge about image processing and a camera to use an appropriate combination of processes to execute an image quality control processing operation and attain a desired effect of the image of interest. According to the embodiment, since the image quality control processing includes a set of a plurality of processes that attains identical or similar effects of images, the user can readily obtain an image having a desired effect making use of the image quality control processing.

Furthermore, according to the embodiment, an image type of the image of interest is automatically determined, image quality control processing operations suitable for the determined image type are selected from among the executable image quality control processing operations, and the selection screen which displays the selected image quality control processing operations (that is, picture processing types corresponding to the selected image quality control processing operations) in the order of the priorities are provided as a user interface as shown in FIGS. 7A and 7B. Accordingly burden of selection of an image quality control processing operation from among the image quality control processing operations that is suitable for the image selected by the user is reduced. Although there is a strong demand for image processing apparatuses capable of performing various processes associated with image quality control processing, if the number of processes associated with the image quality control processing is increased, the burden of operation for the user is also increased. However, according to this embodiment, such a disadvantage may be suppressed.

### B. Modifications

### First Modification

In the foregoing embodiment, the selection screen is generated with reference to the image type database 310. However, instead of the image type database 310 or in addition to the image type database 310, a selection screen may be generated by learning a selection that was performed before using the selection screen and utilizing a result of the learning.

A printer according to a first modification has a configuration the same as that of the printer 100 according to the foregoing embodiment and further includes the selection learning unit 244 and the selection learning database 330 which are indicated by dotted lines as shown in FIG. 1. Other components included in the printer according to this modification are the same as those included in the printer 100, and therefore, the components the same as those of the printer 100 are denoted by reference numerals the same as those used for the printer 100 (shown in FIG. 1) and descriptions thereof are omitted.

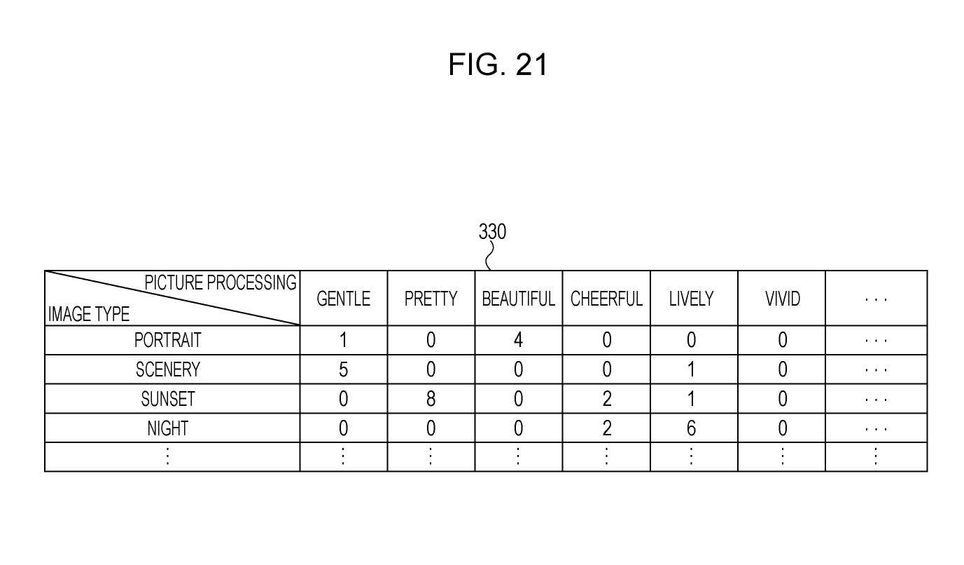

FIG. 21 shows an example of contents of the selection learning database 330. In the selection learning database 330, results of selections of picture processing types performed before by a user are stored as the numbers of selections to be associated with image types of an image of interest. For example, according to the selection learning database 330 shown in FIG. 21, for an image of interest corresponding to an image type of “scenery”, a picture processing type of “gentle” has been selected five times and a picture processing type of “cheerful” has been selected once.

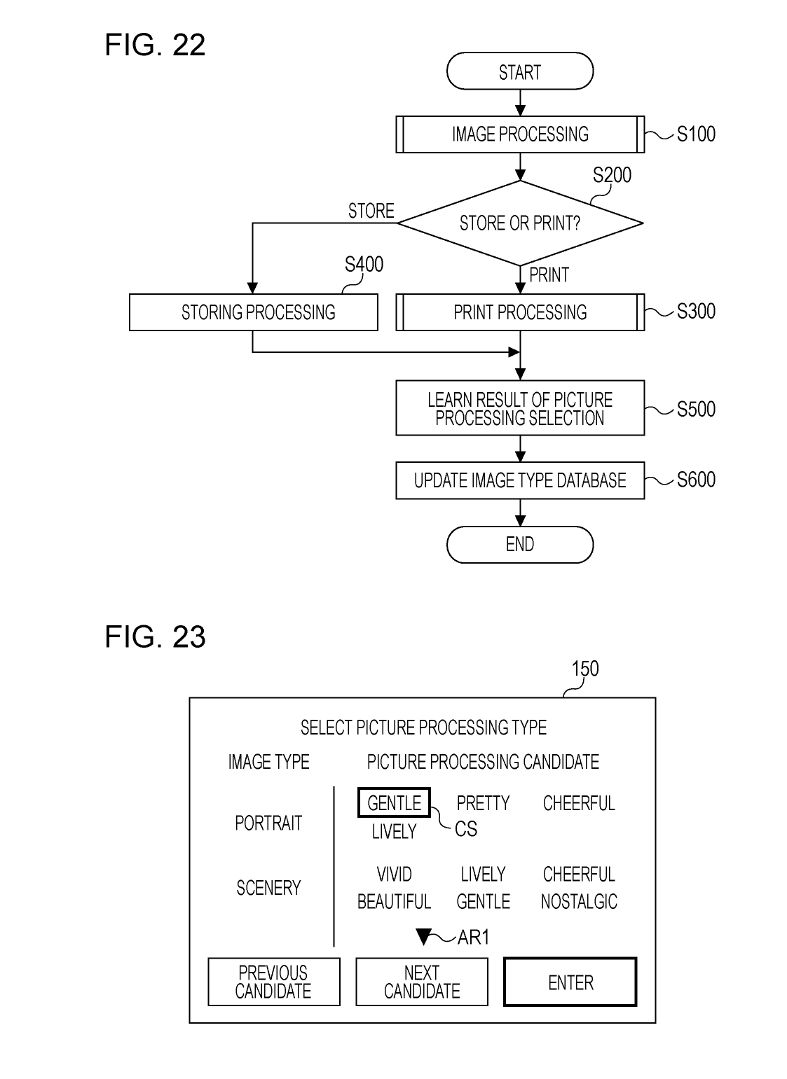

FIG. 22 is a flowchart illustrating picture processing according to the first modification. Step S100 to step S400 of the picture processing according to this modification are the same as step S100 to step S400 of the picture processing shown in FIG. 5 according to the foregoing embodiment, and therefore, descriptions thereof are omitted.

In the picture processing according to this modification, after the printing processing performed on the image of interest is terminated in step S300 or after storing processing performed on the image of interest is terminated in step S400, the selection learning unit 244 learns a result of a selection of a picture processing type in step S500. Specifically, the selection learning unit 244 records a picture processing type which is selected by the user and which is employed for the image of interest finally stored or printed in the selection learning database 330 along with the image type of the image of interest.

After learning the selection result of the picture processing type, the process determination unit 240 updates the image type database 310 as needed in accordance with a change of the selection learning database 330 in step S600. For example, when a picture processing type which has been selected five times or more for a certain image type is included in the selection learning database 330, the process determination unit 240 sets the highest priority to the picture processing type among all picture processing types associated with the image type and records the priority. When a plurality of picture processing types which have been selected five times or more for a certain image type are included in the selection learning database 330, the process determination unit 240 determines an order of priorities of the plurality of picture processing types in a descending order of the numbers of selections thereof and records the priorities thereof in the image type database 310. The picture processing types recorded in the image type database 310 by default have priorities thereof lower than the plurality of picture processing types which have been selected five times or more.

Since the image type database 310 is updated in accordance with the change of the selection learning database 330, a selection screen is generated in the next picture processing with reference to the updated image type database 310. Accordingly, the selection screen generation unit 242 generates a selection screen taking results of selections that have been performed by the user into consideration. According to this modification, the burden, for a user, of a selection of an image quality control processing operation from among the image quality control processing operations is reduced.

The selection learning database 330 described above is merely an example, and various methods for learning results of user's selections or various algorithms for reflecting results of the learning recorded in the selection learning database 330 in operations of generating selection screens may be employed. For example, picture processing types selected by the user for individual face images representing different persons may be recorded in the selection learning database 330. Specifically, features of images of persons (which are represented by vectors indicating positions, sizes, and directions of components such as eye portions, mouth portions, and face contours of face images) and identifiers of the image of persons that are associated with each other are recorded in the selection learning database 330. Furthermore, the numbers of times the picture processing types are selected for an image of interest including a face image specified using one of the identifiers of the persons are recorded to be associated with the identifiers in the selection learning database 330. When a face region FA is detected in the image of interest, the selection learning unit 244 further detects components of the face image such as eye portions, a mouth portion, and a face contour to calculate a feature of a person corresponding to the image of interest. The selection learning unit 244 compares the calculated feature of the person with the features of persons having the identifiers recorded in the selection learning database 330. When it is determined that the calculated feature of the person coincides with one of the features of persons in the selection learning database 330, an identifier is associated with the calculated feature of the person and a result of selection of a picture processing type is recorded in the selection learning database 330. When it is determined that the calculated feature of the person does not coincide with any one of the features of persons in the selection learning database 330, the calculated feature of the person and an identifier thereof are newly stored in the selection learning database 330, and in addition, a picture processing type selected by the user is associated with the identifier and is stored in the selection learning database 330. The selection screen generation unit 242 calculates the feature of the person of the face image included in the image of interest to identify a person corresponding to the face image. Then, the selection screen generation unit 242 refers to the selection learning database 330 to generate a selection screen taking a trend of selections of picture processing types into consideration for each person corresponding to the face image included in the image of interest.

### Second Modification

The selection screen according to the foregoing embodiment may include a “display list” button as indicated by dotted lines in FIGS. 7A and 7B. The “display list” button is a user interface used to accept an instruction for displaying possible picture processing candidates irrespective of a result of determination of an image type. When the user selects the “display list” button, a selection screen shown in FIG. 23 is displayed in the display unit 150.

FIG. 23 is a diagram illustrating a first example of the selection screen. In the selection screen shown in FIG. 23, picture processing candidates which are selectable by a user are displayed as a list to be associated with image types. In the example of FIG. 23, the picture processing candidates associated with image types of “portrait” and scenery are displayed. In this selection screen, when the user selects a “next candidate” button, picture processing candidates associated with image types of “sunset” and “night” are displayed. In this way, the user selects any picture processing type among all picture processing types recorded in the image type database 310 by operating the selection screen. Such a selection screen displayed in response to an instruction issued by the user addresses a problem in that a desired picture processing type is not included in picture processing candidates (shown in FIGS. 7A and 7B) selected in accordance with an image type, for example.

### Third Modification

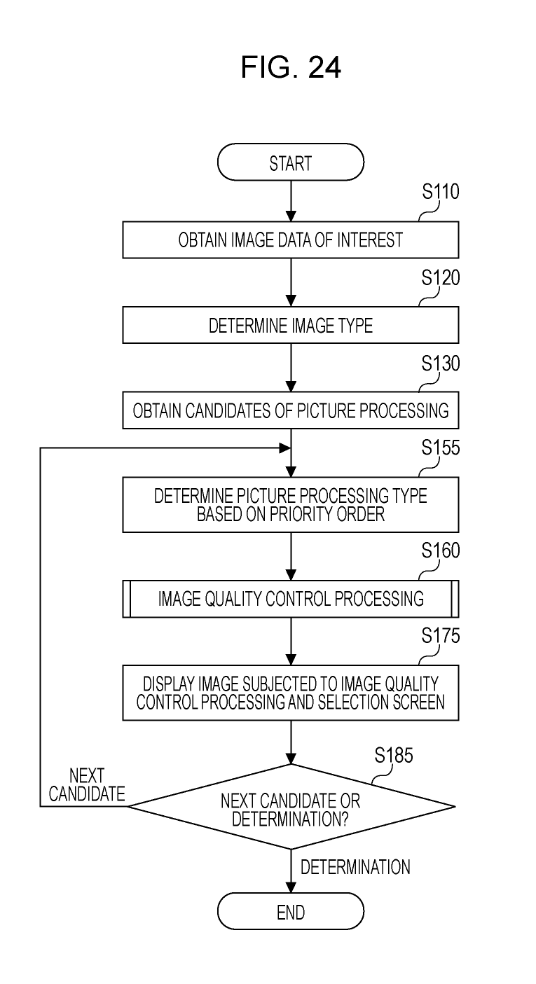

Image processing illustrated in FIG. 24 may be performed instead of the image processing according to the foregoing embodiment shown in FIG. 6.

FIG. 24 is a flowchart illustrating image processing according to a third modification. In FIG. 24, operations performed in step S110, step S120, step S130 and step S160 are the same as those performed in step S110, step S120, step S130 and step S160 of FIG. 6, and therefore, descriptions thereof are omitted.

In the image processing according to this modification, after picture processing candidates are obtained in step S130, the process determination unit 240 determines a picture processing type to be employed among the picture processing candidates in an order of priorities of the picture processing candidates in step S155. For example, when an image type corresponds to “portrait”, picture processing candidates of “gentle”, “pretty”, “beautiful”, “cheerful”, and “lively” (as shown in FIG. 2) are obtained in the order of priorities thereof. Accordingly, the picture processing type of “gentle” is first employed.

When the picture processing type to be employed is determined, as with the image quality control processing (step S160 of FIG. 6) according to the foregoing embodiment, the image quality controller 220 performs one of the image quality control processing operations on an image of interest in accordance with the determined picture processing type in step S160.

When the image quality control processing operation is terminated, a selection screen used by a user to select a desired picture processing type is displayed along with the image of interest that has been subjected to the image quality control processing operation in step S175. Specifically, the selection screen generation unit 242 generates the selection screen including the image of interest that has been subjected to the image quality control processing operation, and the display processing unit 250 controls the display unit 150 to display the selection screen.

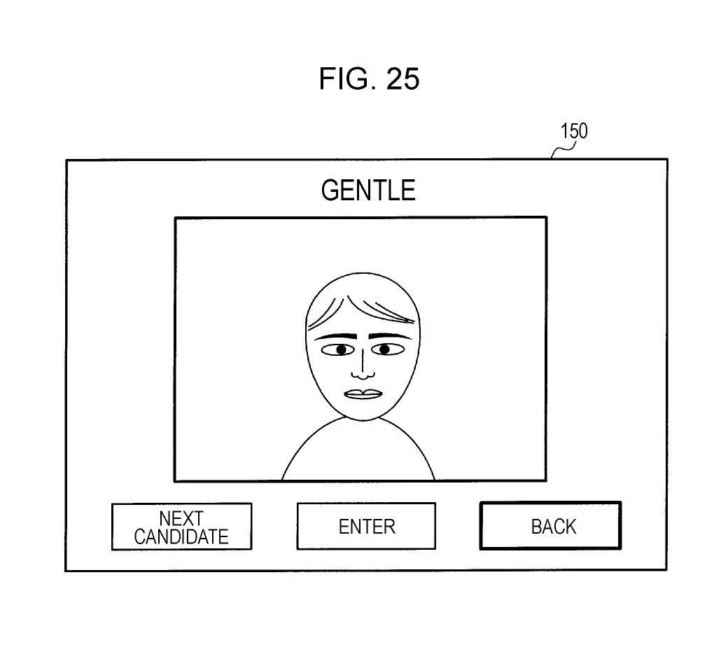

FIG. 25 is a diagram illustrating a second example of the selection screen. When the user selects an “enter” button in the selection screen shown in FIG. 25, the image processing according to this modification is terminated and the process proceeds to storing processing or print processing (shown in FIG. 5). When the user selects a “next candidate” button in the selection screen shown in FIG. 25, the process returns to step S155 where one of the picture processing candidates which has a second highest priority after the picture processing type previously selected in step S155 is newly determined as a picture processing type to be employed. The operations of step S155 to step S185 are repeatedly performed until the user selects the “enter” button in the selection screen.

According to the modification described above, images obtained by performing the image quality control processing operations on the image of interest in accordance with the employed picture processing types are displayed on the selection screen in accordance with the order of the priorities of the picture processing candidates determined in accordance with the image type. Therefore, it is highly likely that an image obtained by performing an image quality control processing operation in which the user desires on an image of interest is displayed on the selection screen at an early stage. Therefore, the user can efficiently select a desired one of the image quality control processing operations. Furthermore, the user can select one of the image quality control processing operations to be finally subjected to the image of interest while successively checking candidate images obtained through the corresponding image quality control processing operations.

Note that, although the images which have been subjected to the image quality control processing operations are displayed one by one in the selection screen shown in FIG. 25, the arbitrary number of images which have been subjected to the image quality control processing operations different from one another may be displayed in the selection screen in accordance with the size of the display unit 150.

### Fourth Modification

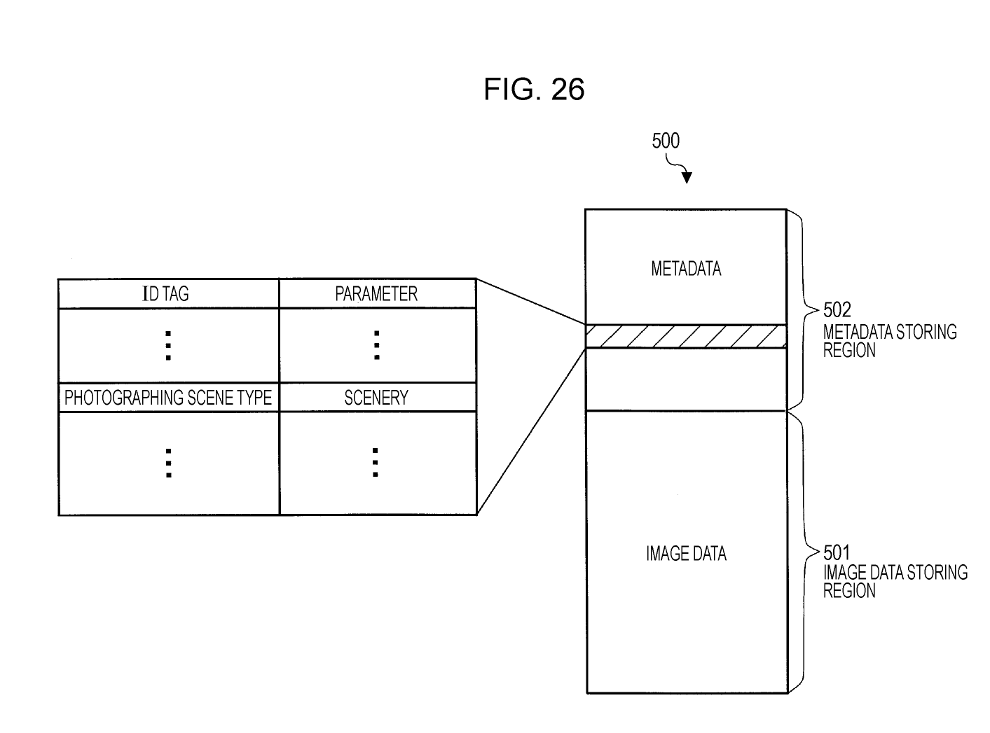

In the foregoing embodiment, the image data representing the image of interest is analyzed so that the image type of the image of interest is determined. However, various methods may be employed in order to determine the image type of the image of interest. For example, metadata of the image data representing the image of interest may be used. FIG. 26 is a diagram schematically illustrating an example of an image file including image data and metadata associated with the image data. An image file 500 includes an image data storing region 501 that stores image data and a metadata storing region 502 which stores metadata. Pieces of metadata are stored in the metadata storing region 502 using tags in accordance with the TIFF (tagged image file format) so that the pieces of metadata are identified by various parameters. The metadata shown in an enlarged manner in FIG. 26 is EXIF (exchangeable image file) data based on the EXIF format. The EXIF data is information on an image corresponding to image data at a time of generation of the image data (at a time when the image is captured) in an image data generation apparatus such as a digital still camera. The EXIF data may include photographing scene type information representing a type of photographing scene as shown in FIG. 26. The photographing scene type information corresponds to “person”, “scenery”, or “night”, for example.

In a case where the photographing scene type information is associated with the image data representing the image of interest as the metadata, the image type determination unit 230 may obtain the photographing scene type information to recognize a photographing scene of the image of interest and to determine an image type.

The metadata used for the determination of the image type is not limited to the EXIF data. For example, the metadata storing region 502 may include therein control information of an image output apparatus such as a printer, that is, printer control information that determines modification levels of the processes of the image quality control processing operation such as a sharpness process and a contrast process. The control information of the image output apparatus is stored in a MakerNote data storing region included in the metadata storing region 502, for example. The MakerNote data storing region is an undefined region which is opened to any maker of the image data generation apparatus or any maker of the image output apparatus. The determination of the image type may be performed solely using the control information of the image output apparatus or using the control information of the image output apparatus, analysis of the image data, and the EXIF data.

### C. Other Modification

Although the steps of the foregoing embodiment and the modifications are shown in the flowcharts, these steps are merely examples. An order of the steps may be changed and some of the steps may be omitted.

As for the relationship between the pixel-value processing and the deformation processing, one of these may be determined as main processing and the other may be determined as sub processing. Alternatively, the pixel-value processing and the deformation processing may be equally associated with each other. For example, in the foregoing embodiment, to attain a “pretty” effect or a “beautiful” effect, the pixel-value processing and the deformation processing may be equally associated with each other. Alternatively, the deformation processing may be performed to cancel an undesired change (such as a change in which a face contour becomes large) that collaterally occurs in the image of interest when the pixel-value processing is performed in order to attain a desired change (such as a change for obtaining high brightness of an image). In this case, the pixel-value processing may be main processing and the face deformation processing may be sub processing.

Furthermore, before performing the picture processing according to the foregoing embodiment, the resolution conversion and the color conversion (step S310 and step S320 in FIG. 20) included in the print processing may be executed.

In the foregoing embodiment, the detection of the face region FA is performed. However, instead of the detection of the face region FA, information on the face region FA may be obtained in response to an instruction issued by a user.

In the foregoing embodiment and the modifications, the print processing performed using the printer 100 serving as the image processing apparatus is described. However, part of or all the picture processing may be performed, except for the print processing, using a control computer or an image processing chip of an image data generation apparatus such as a digital still camera, or using a personal computer. Furthermore, the printer 100 is not limited to the ink jet printer, and may be any other type of printer such as a laser printer or a sublimation printer.

In the foregoing embodiment, part of the configuration implemented by hardware may be implemented by software. Conversely, part of the configuration implemented by software may be implemented by hardware.

Although the embodiment and the modifications according to the invention are described as above, the present invention is not limited to these embodiment and the modifications, and various other modifications may be made within the scope of the invention.

What is claimed is:

1. An image processing apparatus, comprising:
an image quality control unit configured to execute a plurality of image quality control processing operations;
a type determination unit configured to determine an image type among a plurality of image types in accordance with a feature of an image; and
a selection screen generation unit configured to generate a selection screen used to select one of the plurality of image quality control processing operations to be performed on an image in accordance with the determined image type.

2. The image processing apparatus according to claim 1,
wherein the selection screen generation unit determines a priority of the plurality of image quality control processing operations in accordance with the determined image type and generates the selection screen in accordance with the priority.

3. The image processing apparatus according to claim 1,
wherein the selection screen generation unit specifies at least one of the plurality of image quality control processing operations in accordance with the determined image type and generates the selection screen used to select one of at least one of the plurality of image quality control processing operations.

4. The image processing apparatus according to claim 1, further comprising:
a selection learning unit configured to learn selection performed using the selection screen,
wherein the selection screen generation unit generates a selection screen using the determined image type and a result of the learning.

5. The image processing apparatus according to claim 1,
wherein the selection screen generation unit displays the plurality of image quality control processing operations that are associated with at least one of the plurality of image types irrespective of the determined image type in response to an instruction issued by a user.

6. The image processing apparatus according to claim 1,
wherein each of the plurality of image quality control processing operations includes deformation processing of deforming a region included in the image and pixel-value processing of controlling pixel values of pixels included in the image.

7. An image processing method for executing a plurality of image quality control processing operations comprising:
determining an image type among a plurality of image types in accordance with a feature of an image;
generating a selection screen used to select one of the plurality of image quality control processing operations to be performed on the image in accordance with the determined image type; and
performing one of the plurality of image quality control processing operations selected through the selection screen on an image.

8. A computer program stored on a computer readable medium for image processing that makes a computer execute:
an image quality control function of executing a plurality of image quality control processing operations;
a type determination function of determining an image type among a plurality of image types in accordance with a feature of an image; and
a selection screen generation function of generating a selection screen used to select one of the plurality of image quality control processing operations to be performed on the image in accordance with the determined image type.
